(19) United States
(12) Patent Application Publication
(10) Pub. No.: US 2013/0064634 A1
(43) Pub. Date: Mar. 14, 2013

(54) SALT Ring Handling System and Method

(71) Applicants: Trevor S. Brown, Magnolia, TX (US); Vincent H. Barone, Huffmen, TX (US)

(72) Inventors: Trevor S. Brown, Magnolia, TX (US); Vincent H. Barone, Huffmen, TX (US)

(21) Appl. No.: 13/231,312

(22) Filed: Sep. 13, 2011

(51) Int. Cl. B66C 3/04

(52) U.S. Cl. 414/729; 414/815

(57) ABSTRACT

A SALT ring handling system having a platform, a track system operatively connected to a lower side of the platform, and a pickle fork operatively connected to the track system. The platform may include an upper deck, a lower deck, a spacer for positioning the deck near a riser, and an engaging mechanism for operatively connecting the platform to a carrier system. The track system may include a vertical track assembly and a horizontal track assembly for transferring the vertical track assembly in a substantially horizontal direction. The vertical track assembly may include a lift mechanism that is operatively connected to the pickle fork, and the lift mechanism may transfer the pickle fork in a substantially vertical direction. The pickle fork may include one or more extensions for engaging a portion of a SALT ring.

### SUMMARY OF SELECTED EMBODIMENTS OF THE INVENTION

A SALT ring handling system includes a platform, a track system operatively connected to a lower side of the platform, and a pickle fork operatively connected to the track system. The platform may include an engaging mechanism for operatively connecting the platform to a carrier system. The track system may include a vertical track assembly and a horizontal track assembly for transferring the vertical track assembly in a substantially horizontal direction. The pickle fork may be operatively connected to the vertical track assembly. The pickle fork may include an extension for receiving an eyelet of a SALT ring. The vertical track assembly may be capable of transferring the pickle fork in a substantially vertical direction.

The platform may further include an upper deck and a lower deck. The track system may be operatively connected to a lower side of the upper deck. The platform may further include a spacer for positioning the platform near a riser such that the spacer is adjacent to the riser. The SALT ring handling system may further include a storage link for locking the extension of the pickle fork to the spacer of the platform and locking the vertical track assembly and the pickle fork in a substantially parallel position with respect to the platform for storage.

The engaging mechanism may include a guide shoe operatively connected to an end of a leg of the platform extending from a lower side of the upper deck or a lower side of the lower deck. The platform may include two or more legs, each leg extending from the lower side of the upper deck or the lower side of the lower deck to a guide shoe for operatively connecting the platform to a rail of the carrier system. The platform may further include a handrail extending along the periphery of the upper deck and the lower deck. The platform may also include a door in the handrail and a ladder disposed between two of the legs below the door.

The platform may further include one or more lifting eyelets for facilitating lifting of the platform. The vertical track assembly may include a lift mechanism and a frame member having two arms, and the lift mechanism may be slidingly disposed between the two arms. The pickle fork may be operatively connected to the lift mechanism for transferring the pickle fork in a substantially vertical direction along the two arms. The extension of the pickle fork may be disposed between two side extensions of the pickle fork. Each side extension may be for receiving an eyelet of the SALT ring.

The extension of the pickle fork may be dimensioned for engaging an eyelet of a first SALT ring portion, and the SALT ring handling system may further include a second platform, a second track system operatively connected to a lower side of the second platform, and a second pickle fork operatively connected to the second track system. The second platform may include an engaging mechanism for operatively connecting the second platform to the carrier system. The second track system may include a second vertical track assembly and a second horizontal track assembly for transferring the second vertical track assembly in a substantially horizontal direction. The second pickle fork may be operatively connected to the second vertical track assembly. The second pickle fork may include an extension dimensioned to receive an eyelet of a second SALT ring portion. The second vertical track assembly may be capable of transferring the second pickle fork in a substantially vertical direction.

A method for handling a SALT ring may include providing a SALT ring handling system that includes a platform having an engaging mechanism, a track system operatively connected to a lower side of the platform, and a pickle fork operatively connected to the track system. The track system may include a horizontal track assembly and a vertical track assembly. The pickle fork may be operatively connected to the vertical track assembly. The pickle fork may include an extension. The method may also include operatively connecting the engaging mechanism of the platform to a carrier system, and positioning the platform above a SALT ring attached to a parking stand using the carrier system. The method may further include lowering the pickle fork to the SALT ring, engaging the SALT ring with the extension of the pickle fork, disengaging the SALT ring from the parking stand, and lifting the SALT ring attached to the pickle fork using the vertical track assembly and the horizontal track assembly. The method may further include transferring the platform with the SALT ring to a position near a riser using the carrier system such that a spacer of the platform is adjacent to the riser, positioning the SALT ring around the riser using the horizontal track assembly, and locking the SALT ring around the riser.

The method may further include disengaging the extension of the pickle fork from the SALT ring using the horizontal track assembly and the vertical track assembly, and transferring the platform away from the position near the riser using the carrier system. The platform may further include an upper deck and a lower deck, and the engaging mechanism may include a guide shoe operatively connected to an end of a leg of the platform extending from a lower side of the upper deck or a lower side of the lower deck. The method may further include positioning the guide shoe on a rail of the carrier system.

The vertical track assembly may include a lift mechanism slidingly disposed between two arms of a frame member, and the pickle fork may be operatively connected to the lift mechanism. The method may further include lowering the pickle fork to the SALT ring, engaging the SALT ring with the extension of the pickle fork, disengaging the SALT ring from the parking stand, and lifting the SALT ring attached to the pickle fork using the lift mechanism and the horizontal track assembly.

A method for handling a SALT ring may include providing a SALT ring handling system including a first platform having an engaging mechanism, a first track system operatively connected to a lower side of the first platform, a first pickle fork operatively connected to the first track system, a second platform having an engaging mechanism, a second track system operatively connected to a lower side of the second platform, and a second pickle fork operatively connected to the second track system. The first track system may include a first horizontal track assembly and a first vertical track assembly. The first pickle fork may be operatively connected to the first vertical track assembly, and the first pickle fork may include an extension. The second track system may include a second horizontal track assembly and a second vertical track assembly. The second pickle fork may be operatively connected to the second vertical track assembly, and the second pickle fork may include an extension. The method may also include operatively connecting the engaging mechanism of the first platform and the engaging mechanism of the second platform to a carrier system on opposing sides of a riser, positioning the first platform above a first SALT ring portion attached to a first parking stand using the carrier system, and positioning the second platform above a second SALT ring portion attached to a second parking stand using the carrier system. The method may further include lowering the first pickle fork to the first SALT ring portion, engaging the first SALT ring portion with the extension of the first pickle fork, disengaging the first SALT ring portion from the first parking stand, and lifting the first SALT ring portion attached to the first pickle fork using the first vertical track assembly and the first horizontal track assembly. The method may further include lowering the second pickle fork to the second SALT ring portion, engaging the second SALT ring portion with the extension of the second pickle fork, disengaging the second SALT ring portion from the second parking stand, and lifting the second SALT ring portion attached to the second pickle fork using the second vertical track assembly and the second horizontal track assembly.

The method may further include transferring the first platform with the first SALT ring portion to a first position near the riser using the carrier system such that a first spacer of the first platform is adjacent to the riser. The method may further include transferring the second platform with the second SALT ring portion to a second position near the riser using the carrier system such that a second spacer of the second platform is adjacent to the riser. The method may further include positioning the first SALT ring portion and the second SALT ring portion around the riser using the first horizontal track assembly and the second horizontal track assembly. The method may further include locking the first SALT ring portion to the second SALT ring portion around the riser.

The method may further include disengaging the extension of the first pickle fork from the first SALT ring portion using the first horizontal track assembly and the first vertical track assembly. The method may also include disengaging the extension of the second pickle fork from the second SALT ring portion using the second horizontal track assembly and the second vertical track assembly. The method may further include transferring the first platform away from the first position near the riser and transferring the second platform away from the second position near the riser using the carrier system.

The first platform may further include a first upper deck and a first lower deck, and the engaging mechanism of the first platform may include a first guide shoe operatively connected to an end of a leg of the first platform extending from a lower side of the first upper deck or a lower side of the first lower deck. The second platform may further include a second upper deck and a second lower deck, and the engaging mechanism of the second platform may include a second guide shoe operatively connected to an end of a leg of the second platform extending from a lower side of the second upper deck or a lower side of the second lower deck. The method may further include positioning the first guide shoe and the second guide shoe on opposing sides of the riser on a rail of the carrier system.

The first vertical track assembly may include a first lift mechanism slidingly disposed between two arms of a first frame member. The first pickle fork may be operatively connected to the first lift mechanism. The method may further include lowering the first pickle fork to the first SALT ring portion, engaging the first SALT ring portion with the extension of the first pickle fork, disengaging the first SALT ring portion from the first parking stand, and lifting the first SALT ring portion attached to the first pickle fork using the first lift mechanism and the first horizontal track assembly. The second vertical track assembly may include a second lift mechanism slidingly disposed between two arms of a second frame member. The second pickle fork may be operatively connected to the second lift mechanism. The method may further include lowering the second pickle fork to the second SALT ring portion, engaging the second SALT ring portion with the extension of the second pickle fork, disengaging the second SALT ring portion from the second parking stand, and lifting the second SALT ring portion attached to the second pickle fork using the second lift mechanism and the second horizontal track assembly.

### BRIEF DESCRIPTION OF THE DRAWINGS

FIG. 1 is a perspective view of a SALT ring handling system.

FIG. 2 is a top view of a platform of the SALT ring handling system.

FIG. 3 is a side view of the platform.

FIG. 4 is a front view of the platform.

FIG. 5 is a perspective view of the SALT ring handling system in a storage position.

FIG. 6 is a perspective view of a storage link of the platform taken from area 6 in FIG. 5.

FIG. 7 is a side view of the platform in the storage position.

FIG. 8 is a top view of the platform in the storage position.

FIG. 9 is a plan view of portions of a SALT ring each held by a parking stand below a moon deck of a drilling rig.

FIG. 10 is a perspective view of the SALT ring handling system engaging the SALT ring portions supported by the parking stands.

FIG. 11 is a plan view of the SALT ring handling system and the SALT ring portions positioned at the riser in the rail space of the moon deck.

FIG. 12 is a plan view of the SALT ring portions positioned on the riser in the rail space of the moon deck.

### DETAILED DESCRIPTION OF THE PREFERRED EMBODIMENTS

A split auxiliary line termination ring (SALT ring) connects to an outer surface of a riser connected to a subsea wellhead. One such SALT ring is offered by Dril-Quip Inc. More specifically, the SALT ring may connect to a telescopic joint of the riser. The SALT ring replaces auxiliary goosenecks for connecting draping lines extending from a drilling rig to rigid auxiliary lines attached to the riser sections. The SALT ring provides for faster attachment of the draping lines to the rigid auxiliary lines. The SALT ring may have two portions that fit around the outer surface of telescopic joint of the riser. The two portions of the SALT ring may connect and lock together around the telescopic joint with hydraulic latches.

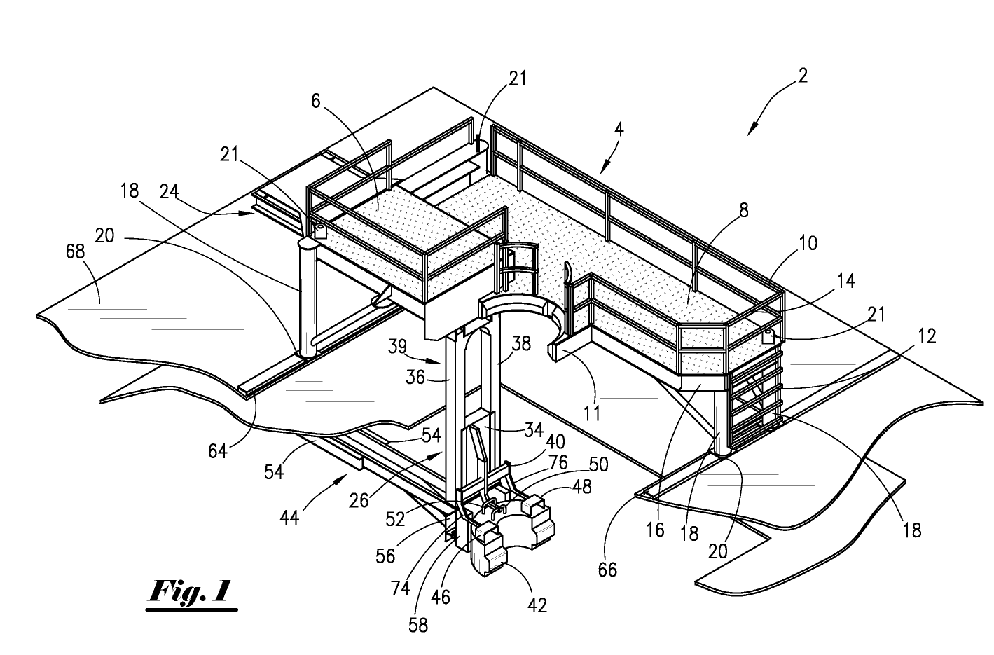

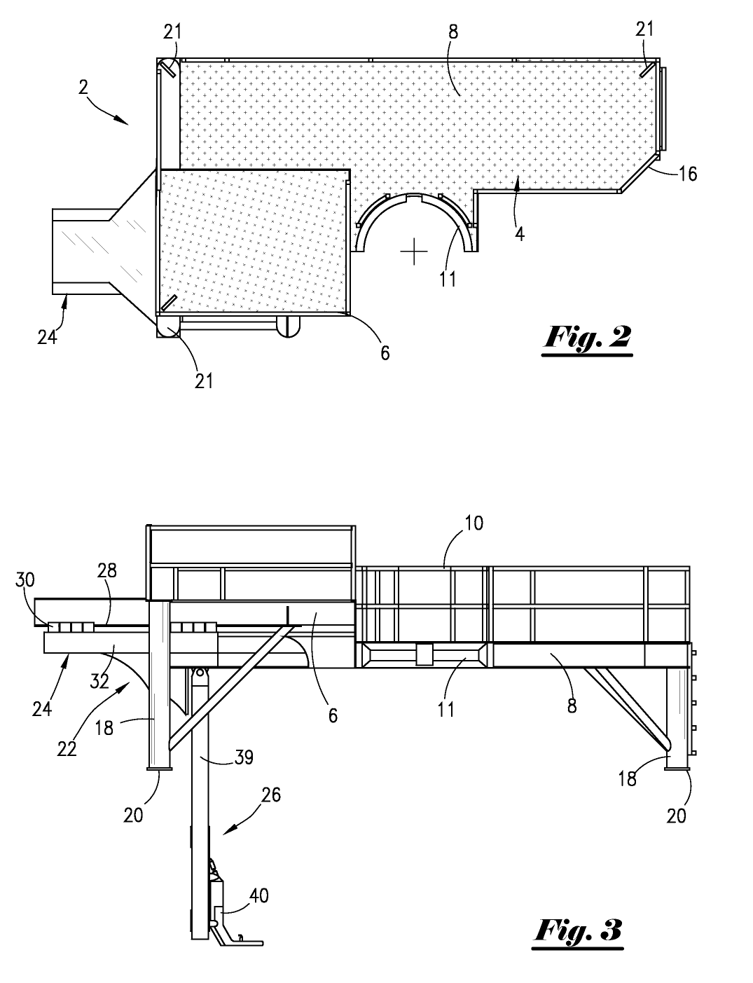

FIGS. 1-4 show one half of SALT ring handling system 2. Platform 4 may include upper deck 6 and lower deck 8 having handrails 10 around the perimeter of both decks 6 and 8. Lower deck 8 may include spacer 11 for positioning platform 4 at a position with respect to a sub-sea riser leading to a sub-sea wellhead. In this position, spacer 11 may be adjacent to the riser. Ladder 12 may lead up to door 14, which interconnects handrails 10 on forward end 16 of platform 4. Platform 4 may be supported by legs 18 extending from the lower surfaces of upper deck 6 and lower deck 8 and terminating at guide shoes 20. Guide shoes 20 may provide a mechanism for operatively connecting platform 4 to a rail of a carrier system for moving platform 4. Alternatively, a clevis pin type connection may be used to connect platform 4 to the rail of the carrier system. Platform 4 may further include one or more lifting eyelets 21 for lifting platform 4 (e.g., by crane). Platform 4 may have an overall length of approximately 26 feet and 1 inch. Platform 4 may have an overall width of approximately 12 feet and 2 inches. Platform 4 may have a height from handrail 10 of upper deck 6 to guide shoe 20 of approximately 10 feet and 1 inch, and a height from lower deck 8 to guide shoe 20 of approximately 4 feet and 9 inches. Upper deck 6 and lower deck 8 may be designed to support approximately 100 lbs. per square foot, with a maximum of approximately 4,000 lbs. total.

Track system 22 may be affixed to the lower surface of upper deck 6. Track system 22 may include horizontal track assembly 24 and vertical track assembly 26. Horizontal track assembly 24 may include tracks 28, guides 30 slidingly disposed around each track 28, and base 32 affixed to guides 30 and vertical track assembly 26. Vertical track assembly 26 may include lift mechanism 34 disposed between arms 36 and 38 of frame member 39. Lift mechanism 34 may support pickle fork 40. Lift mechanism 34 may move pickle fork 40 in a substantially vertical direction, and horizontal track assembly 24 may move vertical track assembly 26 with pickle fork 40 in a substantially horizontal direction along tracks 28. Lift mechanism 34 may move pickle fork 40 substantially vertically for a distance of approximately 2 feet. Horizontal track assembly 24 may move vertical track assembly 26 substantially horizontally for a distance of approximately 5 feet and 6 inches. Track system 22 including pickle fork 40 may be designed to handle a 36,000 lb. load. The distance from handrail 10 of upper deck 6 to the bottom of pickle fork 40 may be approximately 20 feet and 2 inches.

The movement of lift mechanism 34 and horizontal track assembly 24 may be hydraulically controlled. The hydraulic power supply may have a capacity of approximately 3,000 psi at 30 gallons per minute. Each platform 4 may have two hoses for attachment to the hydraulic supply. Each hose may have a diameter of approximately 1 inch. Horizontal track assembly 24 may include a hydraulic motor with a rack and pinion for transferring vertical track assembly 26 in a substantially horizontal direction. Plumbing for the hydraulic motor may include tubing and jumper hoses. Horizontal track assembly 24 may also include a spring-center-operated control valve, which is a selector due to a blocked center position. The control valve may have a control handle. Horizontal track assembly 24 may further include two pressure flow control valves for regulating the supply and return of hydraulic fluid, two pilot operated check valves for locking the cylinder in the last operated position, and two relief valves set at approximately 1,800 psi to avoid overloading the structure.

Vertical track assembly 26 may include two hydraulic cylinders for transferring lift mechanism 34 in a substantially vertical direction. Plumbing for the hydraulic cylinders may include tubing and jumper hoses. Vertical track assembly 26 may also include a guide system running on stainless steel and Nylatron sliding pads for low friction and smooth operation, as well as corrosion resistance. Vertical track assembly 26 may also include a spring-center-operated control valve, which is a selector due to a blocked center position. The control valve may have a control handle. Vertical track assembly 26 may further include two pressure flow control valves for regulating the supply and return of hydraulic fluid, two pilot operated check valves for locking the cylinder in the last operated position, and two relief valves set at approximately 1,900 psi to avoid overloading the structure.

Vertical track assembly 26 may further include a tilt hydraulic cylinder for tilting pickle fork 40 up to 10 degrees of rotation. Plumbing for the tilt hydraulic cylinder may include tubing and jumper hoses. Pins may have grease zerks for lubrication. Vertical track assembly 26 may also include a spring-center-operated control valve for the tilt hydraulic cylinder, which is a selector due to a blocked center position. The control valve may have a control handle. For the tilt hydraulic cylinder, vertical track assembly 26 may further include two pressure flow control valves for regulating the supply and return of hydraulic fluid, two pilot operated check valves for locking the cylinder in the last operated position, and two relief valves set at approximately 2,200 psi to avoid overloading the structure.

Alternatively, movement of lift mechanism 34 and horizontal track assembly 24 may be controlled electronically or pneumatically. Each platform 4 may further include a control panel with controls designed to allow an operator on each platform 4 to control the movement of horizontal track assembly 24 and vertical track assembly 26. The control panel may be located on lower deck 8. Alternatively, the control panel may be located on upper deck 6.

Platform 4, track system 22, and pickle fork 40 may be formed of carbon steel or another material having a strength sufficient to bear the loads discussed above.

Through the movements of lift mechanism 34 and horizontal track assembly 24, pickle fork 40 may engage and lift SALT ring portion 42 from parking stand 44. More specifically, pickle fork 40 may engage side eyelets 46 and 48, center eyelet 50, and rear eyelet 52 of SALT ring portion 42. Parking stand 44 may include supports 54, passage 56, and engaging member 58. SALT ring portion 42 may be attached to engaging member 58 of parking stand 44 for storage. Passage 56 may be dimensioned to receive an end of pickle fork 40 for removing SALT ring portion 42 from engaging member 58 of parking stand 44.

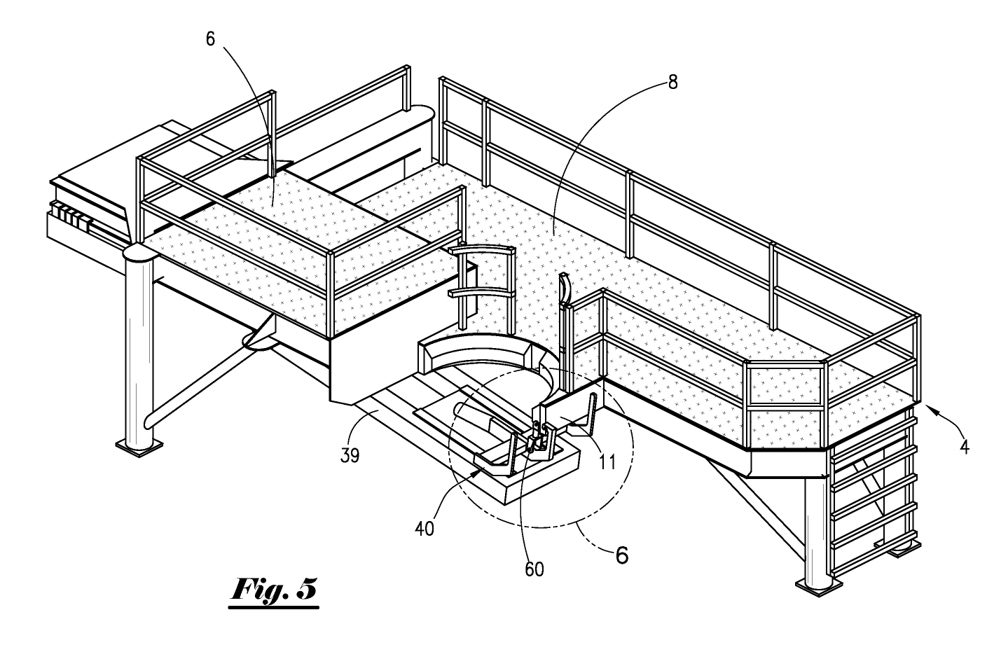

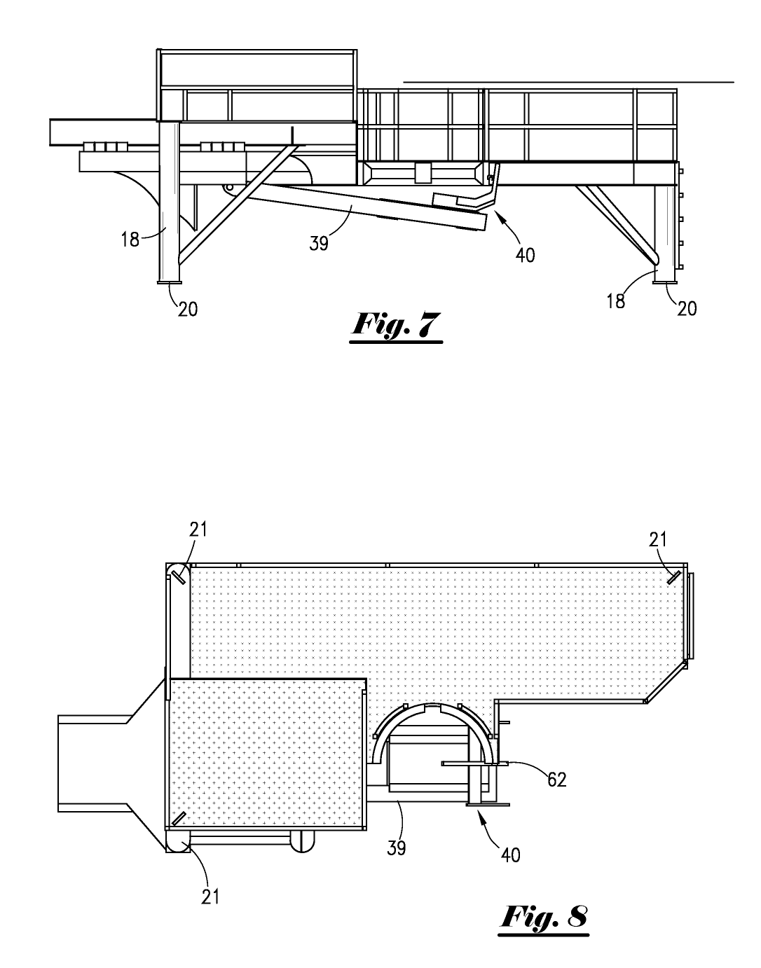

Referring now to FIGS. 5-8, frame member 39 of vertical track assembly 26 may be folded into a substantially horizontal position as shown for storage or transportation. Alternatively, vertical track assembly 26 may be folded into a substantially parallel position with respect to platform 4. Storage link 60 may extend from platform 4. In FIG. 6, storage link 60 extends from spacer 11 of platform 4. Storage link 60 may engage pickle fork 40 such that frame member 39 is locked in the horizontal or parallel position. For example, a bolt or screw may engage a bore through center extension 62 of pickle fork 40 as shown in FIG. 6. System 2 may have a total weight of approximately 22,000 lbs.

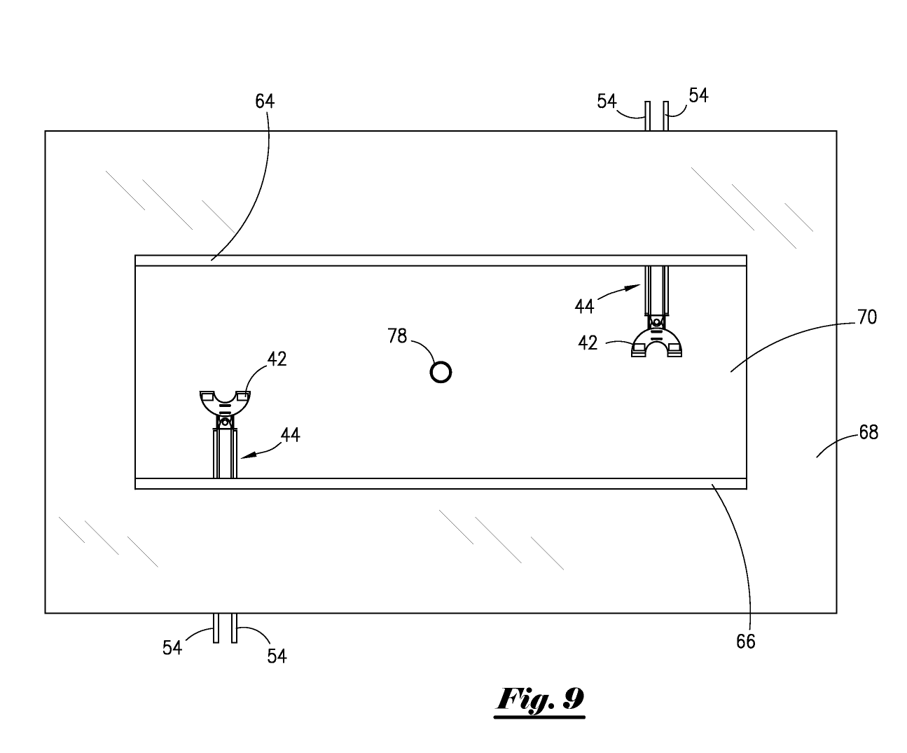

As shown in FIG. 9, SALT ring portions 42 may be positioned on parking stands 44 below moon deck 68 of a drilling rig with SALT ring portions 42 positioned in rail space 70, i.e., the space between rails 64 and 66 of a carrier system on moon deck 68. The carrier system may be a BOP carrier system existing on moon deck 68. Alternatively, the carrier system may include a ratchet style gripper system, a pancake style gripper system, or a gear rack system, and may be powered by the hydraulic control, electronic control, or pneumatic control of track systems 22 on platforms 4. Supports 54 of parking stands 44 may extend or retract SALT ring portions 42 into or out of rail space 70. SALT ring portions 42 may be extended approximately 6 feet and 8 inches into rail space 70. Rails 64 and 66 may each have a width of approximately 9 inches, and may be spaced approximately 20 feet and 3 inches apart.

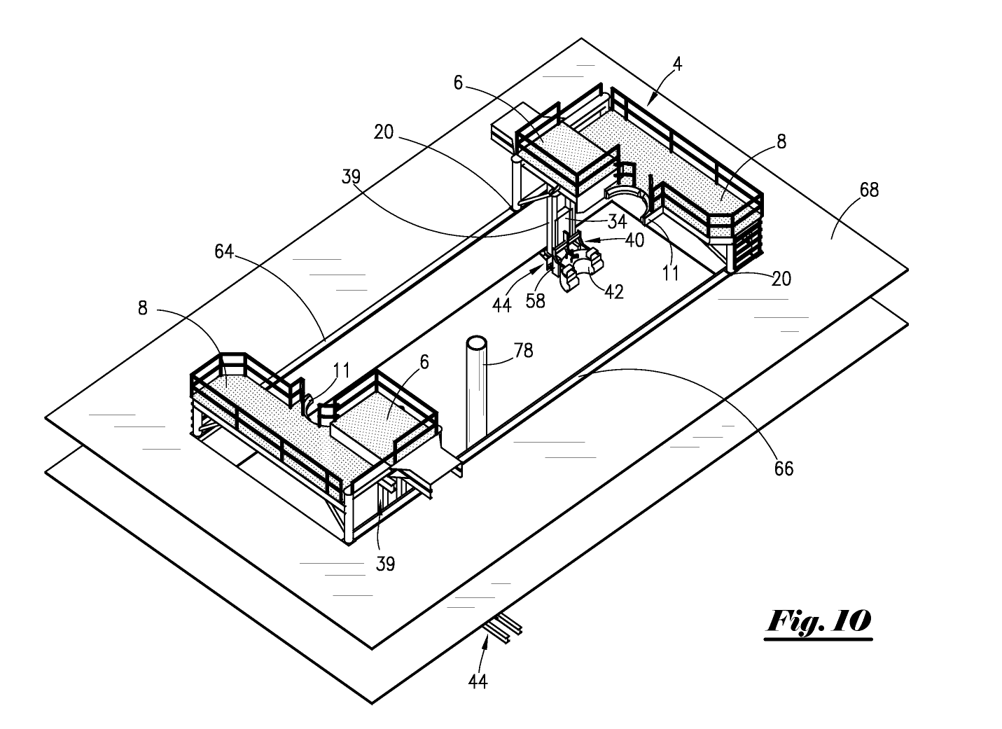

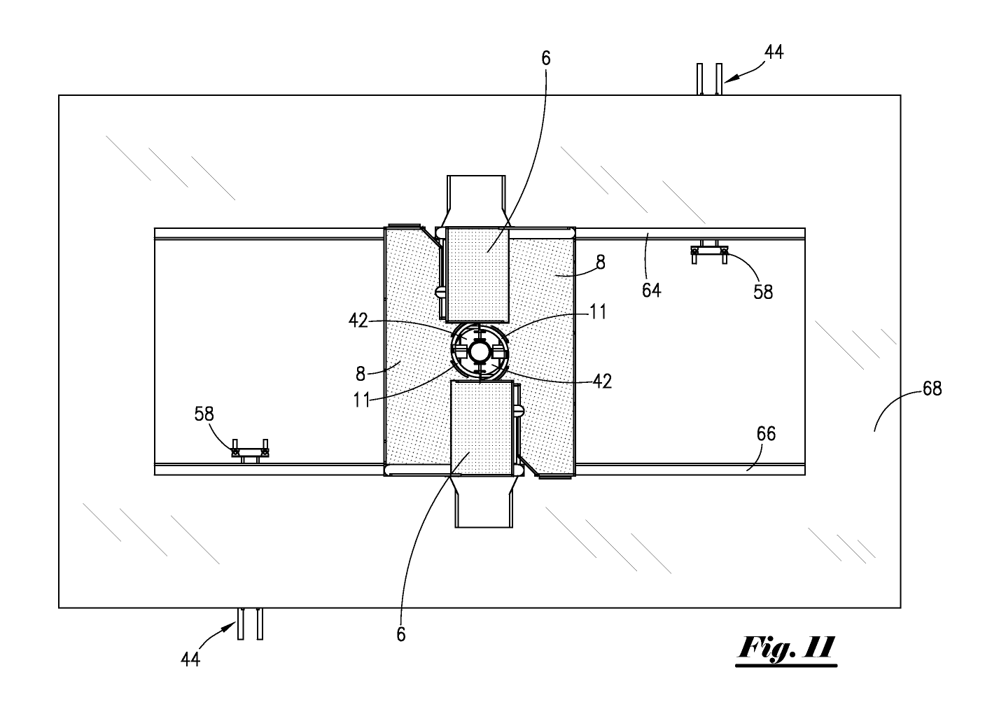

With reference now to FIG. 10, platforms 4 may be positioned on rails 64 and 66. Guide shoes 20 (not shown) may engage rails 64 and 66. Alternatively, guide plates may be used to engage rails 64 and 66. The carrier system may be used to move platforms 4 on rails 64 and 66 until upper decks 6 are positioned over SALT ring portions 42 as shown.

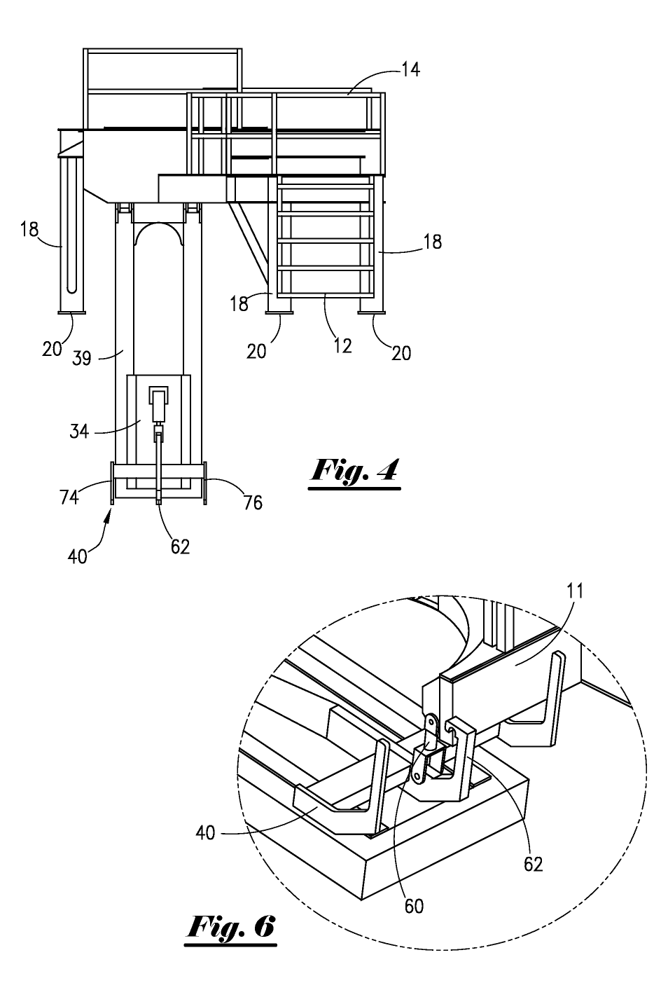

Horizontal track assemblies 24 and lift mechanisms 34 may be used to engage SALT ring portions 42 with pickle forks 40. Specifically, each pickle fork 40 may be lowered on lift mechanisms 34 until center extension 62 and side extensions 74, 76 (shown in FIGS. 1 and 4) of each pickle fork 40 are vertically aligned with eyelets 46, 48, 50, 52 of each SALT ring portion 42. Each horizontal track assembly 24 may be used to extend each pickle fork 40 through eyelets 46, 48, 50, 52 until center extension 62 of each pickle fork 40 contacts rear eyelet 52 of each SALT ring portion 42. Each lift mechanism 34 may then be used to lift each pickle fork 40 until center extension 62 of each pickle fork 40 contacts center eyelet 50 of each SALT ring portion 42. Each horizontal track assembly 24 may then be used to retract each pickle fork 40 until a lip of center extension 62 of each pickle fork 40 contacts center eyelet 50 of each SALT ring portion 42. Each lift mechanism 34 may then be used to again lift each pickle fork 40 until center eyelet 50 of each SALT ring portion 42 engages a depression in center extension 62 of each pickle fork 40. In this way, center extension 62 of each pickle fork 40 engages rear eyelet 52 and center eyelet 50 of each SALT ring portion 42, and side extensions 74, 76 of each pickle fork 40 engages side eyelets 46, 48 of each SALT ring portion 42 (as shown in FIGS. 1 and 4). A lock on each parking stand 44 may be released, and each SALT ring portion 42 may be lifted using each lift mechanism 34 to remove each SALT ring portion 42 from engaging member 58 of each parking stand 44.

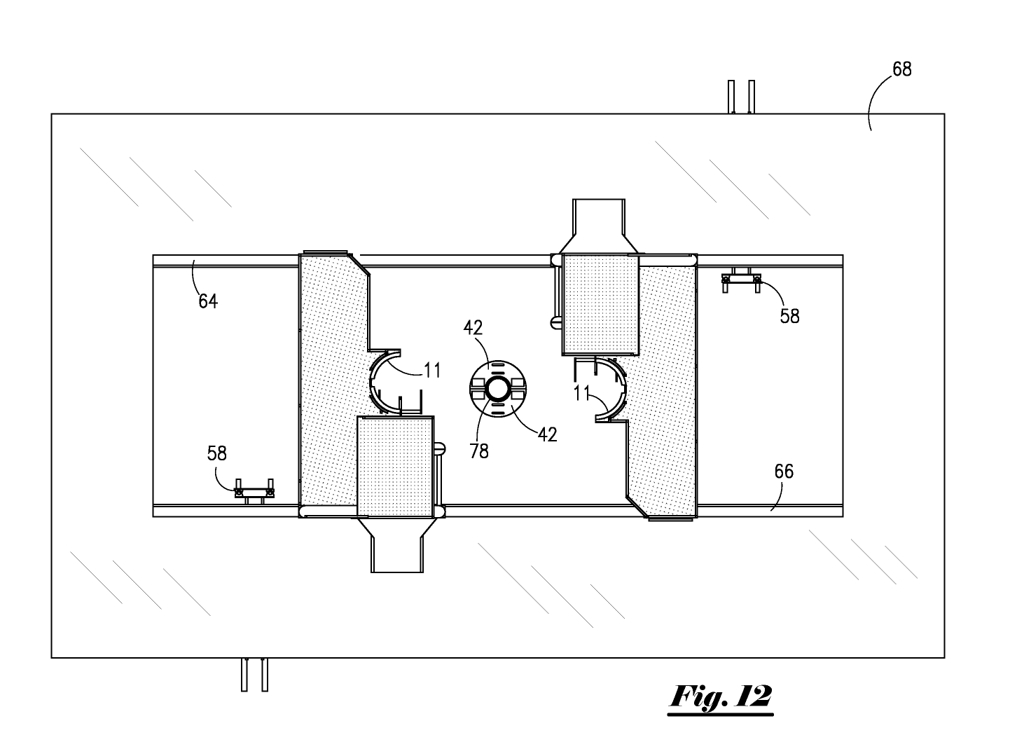

As shown in FIG. 11, platforms 4 may then be moved along rails 64 and 66 until spacers 11 are adjacent to riser 78 as shown in FIG. 12. Horizontal track assemblies 24 may then be used to move SALT ring portions 42 on pickle forks 40 toward riser 78 until SALT ring portions 42 engage riser 78 and one another. Riser 78 may need to be rotated and adjusted vertically for alignment with SALT ring portions 42 before horizontal track assemblies 24 are used to move SALT ring portions 42 toward riser 78.

SALT ring portions 42 may be locked together as shown in FIG. 12 to form a SALT ring. Center and side extensions 62, 74, 76 of pickle forks 40 may be removed from center, rear, and side eyelets 50, 52, 46, 48 of each SALT ring portion 42. Thereafter, platforms 4 may be moved away from riser 78 on rails 64 and 66 with the carrier system. Parking stands 44 may be positioned a distance along rails 64 and 66 from the center of riser 78 of at least approximately 20 feet.

Alternatively, one platform 4 may be used to handle the entire SALT ring by transferring the SALT ring from parking stand 44 to riser 78 and locking the SALT ring around riser 78.

While preferred embodiments of the present invention have been described, it is to be understood that the embodiments are illustrative only and that the scope of the invention is to be defined solely by the appended claims when accorded a full range of equivalents, many variations and modifications naturally occurring to those skilled in the art from a review hereof.

I claim:

1. A SALT ring handling system comprising:
a platform comprising an engaging mechanism for operatively connecting said platform to a carrier system;
a track system operatively connected to a lower side of said platform, said track system comprising a vertical track assembly and a horizontal track assembly for transferring said vertical track assembly in a substantially horizontal direction; and
a pickle fork operatively connected to said vertical track assembly, said pickle fork comprising an extension for receiving an eyelet of a SALT ring, wherein said vertical track assembly is capable of transferring said pickle fork in a substantially vertical direction.

2. The SALT ring handling system of claim 1, wherein said platform further comprises an upper deck and a lower deck, wherein said track system is operatively connected to a lower side of said upper deck.

3. The SALT ring handling system of claim 2, wherein said platform further comprises a spacer for positioning said platform near a riser such that said spacer is adjacent to said riser.

4. The SALT ring handling system of claim 3, further comprising a storage link for locking said extension of said pickle fork to said spacer of said platform and locking said vertical track assembly and said pickle fork in a substantially parallel position with respect to said platform for storage.

5. The SALT ring handling system of claim 2, wherein said engaging mechanism comprises a guide shoe operatively connected to an end of a leg of said platform extending from a lower side of said upper deck or a lower side of said lower deck.

6. The SALT ring handling system of claim 5, wherein said platform further comprises two or more legs, each leg extending from said lower side of said upper deck or said lower side of said lower deck to a guide shoe for operatively connecting said platform to a rail of said carrier system.

7. The SALT ring handling system of claim 6, wherein said platform comprises a handrail extending along the periphery of said upper deck and said lower deck, and wherein said platform further comprises a door in said handrail, and a ladder disposed between two of said legs below said door.

8. The SALT ring handling system of claim 1, wherein said platform further comprises one or more lifting eyelets for facilitating lifting of said platform.

9. The SALT ring handling system of claim 1, wherein said vertical track assembly comprises a lift mechanism and a frame member having two arms, said lift mechanism slidingly disposed between said two arms, and wherein said pickle fork is operatively connected to said lift mechanism for transferring said pickle fork in a substantially vertical direction along said two arms.

10. The SALT ring handling system of claim 1, wherein said extension of said pickle fork is disposed between two side extensions of said pickle fork, each of said side extensions also for receiving an eyelet of said SALT ring.

11. The SALT ring handling system of claim 1, wherein said extension of said pickle fork is dimensioned for engaging an eyelet of a first SALT ring portion; and wherein said SALT ring handling system further comprises:
a second platform comprising a engaging mechanism for operatively connecting said second platform to said carrier system;
a second track system operatively connected to a lower side of said second platform, said second track system comprising a second vertical track assembly and a second horizontal track assembly for transferring said second vertical track assembly in a substantially horizontal direction; and
a second pickle fork operatively connected to said second vertical track assembly, said second pickle fork comprising an extension for receiving an eyelet of a second SALT ring portion, wherein said second vertical track assembly is capable of transferring said second pickle fork in a substantially vertical direction.

12. A method for handling a SALT ring comprising the steps of:
(a) providing a SALT ring handling system comprising: a platform having an engaging mechanism; a track system operatively connected to a lower side of said platform, said track system comprising a horizontal track assembly and a vertical track assembly; and a pickle fork operatively connected to said vertical track assembly, said pickle fork comprising an extension;
(b) operatively connecting said engaging mechanism of said platform to a carrier system;
(c) positioning said platform above a SALT ring attached to a parking stand using said carrier system;
(d) lowering said pickle fork to said SALT ring, engaging said SALT ring with said extension of said pickle fork, disengaging said SALT ring from said parking stand, and lifting said SALT ring attached to said pickle fork using said vertical track assembly and said horizontal track assembly;
(e) transferring said platform with said SALT ring to a position near a riser using said carrier system, wherein in said position a spacer of said platform is adjacent to said riser;
(f) positioning said SALT ring around said riser using said horizontal track assembly; and
(g) locking said SALT ring around said riser.

13. The method of claim 12, further comprising the steps of:
(h) disengaging said extension of said pickle fork from said SALT ring using said horizontal track assembly and said vertical track assembly; and
(i) transferring said platform away from said position near said riser using said carrier system.

14. The method of claim 12, wherein said platform further comprises an upper deck and a lower deck, and wherein said engaging mechanism comprises a guide shoe operatively connected to an end of a leg of said platform extending from a lower side of said upper deck or a lower side of said lower deck, and wherein step (b) further comprises: positioning said guide shoe on a rail of said carrier system.

15. The method of claim 12, wherein said vertical track assembly comprises a lift mechanism slidingly disposed between two arms of a frame member, wherein said pickle fork is operatively connected to said lift mechanism, and wherein step (d) further comprises: lowering said pickle fork to said SALT ring, engaging said SALT ring with said extension of said pickle fork, disengaging said SALT ring from said parking stand, and lifting said SALT ring attached to said pickle fork using said lift mechanism and said horizontal track assembly.

16. A method for handling a SALT ring comprising the steps of:
(a) providing a SALT ring handling system comprising: a first platform having an engaging mechanism; a first track system operatively connected to a lower side of said first platform, said first track system comprising a first horizontal track assembly and a first vertical track assembly; a first pickle fork operatively connected to said first vertical track assembly, said first pickle fork comprising an extension; a second platform having an engaging mechanism; a second track system operatively connected to a lower side of said second platform, said second track system comprising a second horizontal track assembly and a second vertical track assembly; and a second pickle fork operatively connected to said second vertical track assembly, said second pickle fork comprising an extension;
(b) operatively connecting said engaging mechanism of said first platform and said engaging mechanism of said second platform to a carrier system on opposing sides of a riser;
(c) positioning said first platform above a first SALT ring portion attached to a first parking stand and positioning said second platform above a second SALT ring portion attached to a second parking stand using said carrier system;
(d) lowering said first pickle fork to said first SALT ring portion, engaging said first SALT ring portion with said extension of said first pickle fork, disengaging said first SALT ring portion from said first parking stand, and lifting said first SALT ring portion attached to said first pickle fork using said first vertical track assembly and said first horizontal track assembly;
(e) lowering said second pickle fork to said second SALT ring portion, engaging said second SALT ring portion with said extension of said second pickle fork, disengaging said second SALT ring portion from said second parking stand, and lifting said second SALT ring portion attached to said second pickle fork using said second vertical track assembly and said second horizontal track assembly;
(f) transferring said first platform with said first SALT ring portion to a first position near said riser using said carrier system, wherein in said first position a first spacer of said first platform is adjacent to said riser;
(g) transferring said second platform with said second SALT ring portion to a second position near said riser using said carrier system, wherein in said second position a second spacer of said second platform is adjacent to said riser;
(h) positioning said first SALT ring portion and said second SALT ring portion around said riser using said first horizontal track assembly and said second horizontal track assembly;
(i) locking said first SALT ring portion to said second SALT ring portion around said riser.

17. The method of claim 16, further comprising the steps of:
(j) disengaging said extension of said first pickle fork from said first SALT ring portion using said first horizontal track assembly and said first vertical track assembly;
(k) disengaging said extension of said second pickle fork from said second SALT ring portion using said second horizontal track assembly and said second vertical track assembly;
(l) transferring said first platform away from said first position near said riser and transferring said second platform away from said second position near said riser using said carrier system.

18. The method of claim 16, wherein said first platform further comprises a first upper deck and a first lower deck, wherein said engaging mechanism of said first platform comprises a first guide shoe operatively connected to an end of a leg of said first platform extending from a lower side of said first upper deck or a lower side of said first lower deck, wherein said second platform further comprises a second upper deck and a second lower deck, wherein said engaging mechanism of said second platform comprises a second guide shoe operatively connected to an end of a leg of said second platform extending from a lower side of said second upper deck or a lower side of said second lower deck, and wherein step (b) further comprises: positioning said first guide shoe and said second guide shoe on opposing sides of said riser on a rail of said carrier system.

19. The method of claim 16, wherein said first vertical track assembly comprises a first lift mechanism slidingly disposed between two arms of a first frame member, wherein said first pickle fork is operatively connected to said first lift mechanism, and wherein step (d) further comprises: lowering said first pickle fork to said first SALT ring portion, engaging said first SALT ring portion with said extension of said first pickle fork, disengaging said first SALT ring portion from said first parking stand, and lifting said first SALT ring portion attached to said first pickle fork using said first lift mechanism and said first horizontal track assembly.

20. The method of claim 19, wherein said second vertical track assembly comprises a second lift mechanism slidingly disposed between two arms of a second frame member, wherein said second pickle fork is operatively connected to said second lift mechanism, and wherein step (e) further comprises: lowering said second pickle fork to said second SALT ring portion, engaging said second SALT ring portion with said extension of said second pickle fork, disengaging said second SALT ring portion from said second parking stand, and lifting said second SALT ring portion attached to said second pickle fork using said second lift mechanism and said second horizontal track assembly.
